(19) United States
(12) Patent Application Publication
(10) Pub. No.: US 2026/0241910 A1
(43) Pub. Date: Aug. 20, 2026

(54) METHOD FOR CONTROLLING A BRAKE SYSTEM WITHOUT A MOTOR POSITION SENSOR

(71) Applicant: AUMOVIO Germany GmbH, Frankfurt am Main (DE)

(72) Inventors: Dominik Schulte, Mühltal (DE); Bogdan Budianu, Oberursel (DE); Tom Kaufmann, Ippenschied (DE)

(73) Assignee: AUMOVIO Germany GmbH, Frankfurt am Main (DE)

(21) Appl. No.: 19/545,354

(22) Filed: Feb. 20, 2026

(30) Foreign Application Priority Data
Feb. 20, 2025 (DE) 10 2025 106 546.2
Jul. 3, 2025 (DE) 10 2025 125 925.9

(51) Int. Cl. B60T 13/74; B60T 8/171; B60T 8/172

(52) U.S. Cl. CPC B60T 13/745; B60T 8/171; B60T 8/172

(57) ABSTRACT

A method comprises controlling a hydraulic motor vehicle brake system having an electric pressure providing device which is driven by an electric synchronous machine. In order to operate the synchronous machine without a rotational position sensor, the actuation of the synchronous machine is realized by extended I-f control, wherein a requested rotational speed variable for the synchronous machine is received the requested rotational speed variable is limited, based on the limited rotational speed variable and a system pressure, a d current and a q current are determined, based on the limited rotational speed variable, a virtual rotational angle is determined, and the actuation of the synchronous machine is realized based on the virtual rotational angle, d current and q current.

### TECHNICAL FIELD

A method for controlling an electric pressure providing device of a hydraulic motor vehicle brake system, which is driven by an electric synchronous machine, and to a corresponding brake system.

### BACKGROUND

From the prior art, in the field of motor vehicle technology, in particular of electronic brake systems, so-called permanent magnet synchronous machines are known, for the actuation of which field-oriented current regulators are often used; this is also referred to as vector control. Such current regulators usually require a suitable sensor for determining the current rotor position. For this purpose, the currents are transmitted by means of the present rotor position into the rotating reference frame of the rotor, thus resulting in a d current and a q current which can be easily controlled.

In this context, DE 10 2011 086 572 A1 discloses a method for the variable-speed control of a positive displacement pump unit for conveying a fluid. The positive displacement pump unit consists of a positive displacement pump and a drive, wherein the drive in turn consists of an electric drive motor and a frequency converter. In order to control the positive displacement pump unit to a final pressure setpoint value, state values, in particular position, rotational speed and torque of the drive motor, which are supplied by the drive by means of a control device, are detected. By means of these state values and the use of a known motor torque final pressure dependency, the positive displacement pump unit can be regulated to the final pressure setpoint value without the use of pressure sensors.

DE 10 2010 034 940 A1 discloses a method for operating an electric-motor-commutated brushless DC motor by means of a microprocessor. In this context, the DC motor contains a stator, a rotor and an electromagnet, wherein the electromagnet is located as a winding around the rotor or within the rotor. The stator also comprises a series of permanent magnet poles. The microprocessor executes an algorithm that controls the motor commutation and regulates the voltage at the DC motor. By means of a detection unit, in each case the current rotor position or a rotational speed of the DC motor is detected in the form of a rotor position signal and transmitted to the microprocessor. Here, the current rotor position is detected without sensors according to the so-called back-electromotive-force principle.

However, the methods either have cost-intensive position sensors to be used to determine the position of the rotor position or, if a so-called sensorless rotor position determination is carried out in accordance with the back-electromotive-force principle, the determination of the position of the rotor position in the range of low rotational speeds is inaccurate since the back-voltage of the motor is only very low in this rotational speed range. In the low-speed range, however, a drive for a so-called electric power-on-demand brake system, which can be activated substantially immediately on demand, must be able to convert high powers in order to be able to initiate an emergency braking operation as promptly as possible. Likewise, it may be necessary to generate a high static motor torque at low rotational speeds and a simultaneous modulation of high brake pressures.

### SUMMARY

An improved method for sensorless regulation of a pump unit in an electrohydraulic vehicle brake system is proposed.

Achieved by a method for controlling a hydraulic motor vehicle brake system having an electric pressure providing device which is driven by an electric synchronous machine, wherein the actuation of the synchronous machine is realized by means of extended I-f control.

The extended I-f control comprises that a requested rotational speed variable for the synchronous machine is received, the requested rotational speed variable is limited, a d current and a q current are determined based on the limited rotational speed variable and a system pressure, a virtual rotational angle is determined based on the limited rotational speed variable, and the actuation of the synchronous machine is realized based on the virtual rotational angle, d current and q current.

Here, the system pressure is for example the pressure which acts on the pressure providing device. In motor vehicle brake systems, this is typically determined by means of a pressure sensor.

The synchronous machine is a three-phase, electronically commutable, permanently excited and brushless electric motor which is driven by means of a current-regulated, rotating magnetic field generated by means of a three-phase current. In this context, the motor torque-generating current can also be calculated from the output motor torque. The synchronous machine comprises a permanently magnetically excited rotor and an electromagnetically excitable stator. In this case, the rotor is a rotatably mounted element of the synchronous machine which is set in rotation by the action of the magnetic field of the stator. A synchronous machine of said type is also known as a so-called permanent magnet synchronous machine.

In one embodiment, the limiting of the rotational speed variable is performed based on a current load, for example based on the system pressure. The limiting is greater the larger the load, for example the greater system pressure, is. This ensures that the motor does not lose synchronization even under high load.

In an embodiment, the limiting comprises a rotational speed limit value and a rotational acceleration limit value. Thus, firstly, the rotational speed is limited directly to the rotational speed limit value if it exceeds this. Secondly, for the rotational acceleration limit value, a previous rotational speed is considered and the rotational speed is limited in such a way that it differs from the previous rotational speed value by the maximum rotational acceleration limit value. When viewed discretely, this may simply be the last rotational speed value. It is also possible to use predetermined time differences. The rotational speed limit value and the rotational acceleration limit value can both be determined as a function of load and system pressure, respectively.

In one embodiment, an estimated rotational acceleration is determined from the limited rotational speed variable, which estimated rotational acceleration is used in addition to the d current and q current determination. For this purpose, the limited rotational speed variable can be compared with a previous limited rotational speed variable.

In one embodiment, the q current is determined based on a required motor torque. In comparison with a simple I-f control, the current is therefore only as large as is required in order to provide a required motor torque, thus avoiding a situation in which an excessively high current leads to overheating. As a result, the actuation can also be carried out permanently or at least for longer periods of time than with a simple I-f control.

In one embodiment, the required motor torque is determined from a sum of load variables.

In one embodiment, the d current is determined based on absolute values of individual load variables. The d current can thus ensure that synchronicity is maintained even with many large individual load variables.

In one embodiment, a minimum value for the d current is provided. In this way, stability of the motor drive is guaranteed independently of the actual determined variables. The minimum value can be set to 20 A, for example.

In one embodiment, a maximum value is provided for the total current, wherein the d current is limited in such a way that the total current does not exceed the maximum value. The magnitude of the q current is thus determined first, and the d current is then limited in such a way that the total current remains less than or equal to the maximum value. Since the current vectors of the d current and the q current are perpendicular to one another,

$$the relationship \sqrt{{I}_{q}^{2} + {I}_{d}^{2}} \leq {I}_{max} is used .$$

In one embodiment, the load variables comprise a position variable, a speed variable and an acceleration variable. In a motor vehicle brake system, the position variable is for example the system pressure. The further the synchronous motor moves forward a piston-cylinder arrangement, the higher the counterpressure, since the brake system with wheel brakes can simply be regarded as a non-linear spring system. Since the pressure generated in the vehicle brake system and the motor torque are related to one another in a fixed mathematical relationship, it is thus possible to determine the motor torque by means of the pressure sensor, for example also by means of a plurality of pressure sensors. In most vehicle brake systems, the presence of at least one pressure sensor, which is required for the regulation of the system preliminary pressure, is provided as standard. Consequently, no additional cost expenditure arises for the implementation of the method.

The speed variable comprises for example the speed-dependent friction. The acceleration variable can be determined from the change in rotational speed and the moment of inertia of the arrangement.

In one embodiment, the d current and q current are converted by means of the virtual rotational angle into current values for individual stator windings, and these are supplied with the current values.

In one embodiment, in a fault-free case, field-oriented actuation of the synchronous machine is performed by means of rotor position sensor, and in the event of failure of the rotor position sensor, the actuation is performed by means of extended I-f control.

The idea is also achieved by means of a hydraulic motor vehicle brake system having an electric pressure providing device which is driven by an electric synchronous machine, and a control unit for actuating the synchronous machine, wherein the control unit is configured to perform the actuation of the electric synchronous machine by means of an above method, i.e. in the event of failure of a rotor position sensor.

### BRIEF DESCRIPTION OF THE DRAWINGS

Further features, advantages and possible uses will be apparent from the following description of exemplary embodiments and from the figures. Here, all the features described and/or illustrated in the figures are, in principle, the subject matter of the embodiments, individually or in any desired combination, irrespective of whether they are combined in the claims or the back-references thereof.

FIG. 1 schematically shows the extended I-f control; and

FIG. 2 schematically shows a detail of the extended I-f control.

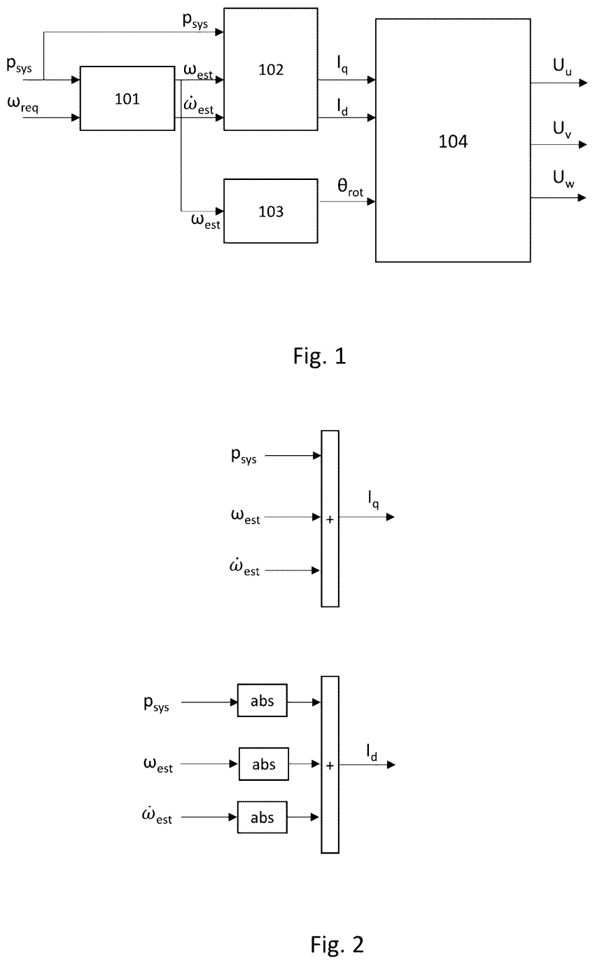

### DETAILED DESCRIPTION

In the course of implementing a braking request by means of an electric pressure providing device, a rotational speed request ω_{req} is determined by a superordinate controller, which rotational speed request is received by the extended I-f control system. This is limited in limiting 101 based on a current system pressure which is measured by means of a pressure sensor in the hydraulic brake system. The pressure is the pressure which acts on a piston of the electric pressure providing device, which is designed as a linear actuator, that is to say as a cylinder-piston arrangement.

In the limiting 101, a rotational speed limit value and a rotational acceleration limit value are determined first. For this purpose, a relationship between the two limit values and the current system pressure can be stored in the regulation. A linear relationship, a quadratic relationship or other relationships with corresponding conversion factors are possible.

The application of the rotational speed limit value to the rotational speed request ω_{req} can be carried out directly. For the application of the rotational acceleration limit value, the last value of the rotational speed, the estimated rotational speed ωₑₛₜ, is also considered and the change in the rotational speed is limited to this value. The rotational speed request which is thus limited twice is output as an estimated rotational speed ωₑₛₜ. In addition, a rotational speed change or estimated rotational acceleration \dot{ω}ₑₛₜ is determined and output on the basis of the estimated rotational speed ωₑₛₜ and the last estimated rotational speed ωₑₛₜ.

These values are passed on to the current vector determination 102, which determines the current vector comprising the two components d current and q current, and is illustrated in detail in FIG. 2. In order to determine the q current which provides motor torque, the load values are summed. This is a motor torque fraction resulting from the system pressure, which exerts a force over the piston surface, which force leads to a torque via a rotation-translation mechanism of the pressure providing device. A second torque which counteracts the current rotational speed ωₑₛₜ acts through friction effects. A third torque is determined by the rotational acceleration \dot{ω}ₑₛₜ and the moment of inertia of the rotating parts. All these components are added together and thus determine an overall torque. Here, the components may also be negative, for example if the rotational speed of the motor is to be reduced. The q current is calculated from the overall torque by means of a conversion factor.

For the d current, the same components are used, but these are converted into the absolute values beforehand by means of magnitude formation. The sum of these absolute values then becomes the d current value with appropriate conversion.

The rotational angle determination 103 uses the estimated rotational speed ωₑₛₜ and integrates it in order to obtain the current rotational angle θᵣₒₜ of the rotor.

The rotational angle θᵣₒₜ is made available, together with the determined current setpoint values in the dq system I_{q} and I_{d}, to the current regulator 104, which determines desired voltages which are converted into the actuating voltages u, v, w for the stator windings by means of coordinate transformation into the system of the stator, which calculates therefrom the actuating voltages u, v, w which are obtained from the dq system into the u, v, w system of the stator by means of coordinate transformation.

By limiting the requirement to values which the rotor can follow, together with the motor-torque-dependent determination of the current values in the dq system, the motor can also be operated without a rotor position sensor.

1. A method for controlling a hydraulic motor vehicle brake system comprising:
driving an electric pressure providing device by an electric synchronous machine, wherein the actuation of the synchronous machine is via extended I-f control;
receiving a requested rotational speed variable for the synchronous machine;
limiting the requested rotational speed variable;
determining a system pressure, a d current and a q current based on the limited rotational speed variable;
determining a virtual rotational angle based on the limited rotational speed variable; and
realizing the actuation of the synchronous machine based on the virtual rotational angle, d current and q current.

2. The method according to claim 1, wherein the limiting is based on a system pressure.

3. The method according to claim 1, wherein the limiting comprises a rotational speed limit value and a rotational acceleration limit value.

4. The method according to claim 1, further comprising determining an estimated rotational acceleration ed from the limited rotational speed variable, which is used in addition to the d current and q current determination.

5. The method according to claim 1, further comprising determining the q current based on a required motor torque.

6. The method according to claim 1, further comprising determining the required motor torque from a sum of load variables.

7. The method according to claim 1, further comprising determining the d current based on absolute values of individual load variables.

8. The method according to claim 1, further comprising providing a minimum value for the d current.

9. The method according to claim 1, further comprising providing a maximum value for the total current, wherein the d current is limited such that the total current does not exceed the maximum value.

10. The method according to claim 1, wherein the load variables comprise a position variable, a speed variable and an acceleration variable.

11. The method according to claim 1, further comprising converting d current and q current by the virtual rotational angle into current values for individual stator windings, and these are supplied with the current values.

12. The method according to claim 1, further comprising performing in a fault-free case, field-oriented actuation of the synchronous machine by a rotor position sensor, and in the event of failure of the rotor position sensor, and performing the actuation by the extended I-f control.

13. A hydraulic motor vehicle brake system comprising:
an electric pressure providing device which is driven by an electric synchronous machine; and
a control unit for actuating the synchronous machine in the event of failure of a rotor position sensor with instructions for:
receiving a requested rotational speed variable for the synchronous machine;
limiting the requested rotational speed variable;
determining a system pressure, a d current and a q current based on the limited rotational speed variable;
determining a virtual rotational angle based on the limited rotational speed variable; and
realizing the actuation of the synchronous machine based on the virtual rotational angle, d current and q current.
